(19) United States
(12) Patent Application Publication
(10) Pub. No.: US 2003/0209416 A1
(43) Pub. Date: Nov. 13, 2003

(54) Key cap with multiple-layer structure

(76) Inventor: Yao-Kun Tsai, Pingjen City (TW)

Correspondence Address: SNELL & WILMER, ONE ARIZONA CENTER, 400 EAST VAN BUREN, PHOENIX, AZ, 850040001

(21) Appl. No.: 10/427,221

(22) Filed: May 1, 2003

(30) Foreign Application Priority Data
May 10, 2002 (TW) 91109742

(51) Int. Cl. H01H 13/14

(52) U.S. Cl. 200/341

(57) ABSTRACT

The present invention provides a key cap with a multiple-layer structure for use with a push button switch which having a plunger device. The key cap has a first portion formed by a first material and a second portion formed by a second material. The first portion includes at least one bearing portion connected to the plunger device. The second portion covers the first portion and includes a contact surface for bearing an external force exerted on the cap. The second portion has a thickness smaller than that of the first portion since the strength of the second material is higher than that of the first material.

This application claims priority to Taiwan Patent Application No. 091109742, filed on May 10, 2002.

### FIELD OF INVENTION

The present invention relates to a key cap for use with a mechanical key switch. Particularly, the present invention relates to a key cap with a multiple-layer structure for use with a key of a keyboard.

### BACKGROUND OF THE INVENTION

Generally, switches for use with keyboards include two typical types, mechanical key switches and membrane key switches. Structures and elements of mechanical key switches often lead to needs for special designs to reduce total volume.

FIG. 1 shows an exemplar of a key cap used in a traditional spring-type push button switch. A spring device 113 is disposed between a cap 110 and a base plate 115 to respond to an up-and-down movement of the cap 110. When an external force is exerted on the cap 110, the spring device 113 deforms correspondingly and allows the cap 110 to move downward. To make the illustration of FIG. 1 clearer, the illustrated spring device 113 is simplified.

The cap 110 includes parts for connecting and positioning the spring device 113, such as guide rod 117, plunger 114, and hook 116. The cap 110 also includes a contact surface 112 for bearing the external force exerted on the cap 110. Usually, the cap 110 is formed by polymer material, such as injected plastic material. In addition, the cap 110 must have an appropriate thickness t1 to provide enough strength for bearing the external force.

Similarly, FIG. 2 shows an exemplar of a key cap used in a traditional scissors-type push button switch. A scissors-like device 123 is disposed between a cap 120 and a base plate 115 to respond to an up-and-down movement of the cap 120. The cap 120 and the base plate 115 respectively include bearing portions 124 and 125 for joining to the scissors-like device 123. When an external force is exerted on the cap 120, the scissors-like device 123 is displaced correspondingly and allows the cap 120 to move downward. The spring device 113 in FIG. 1 is also simplified to make the illustration clearer.

The cap 120 is also formed by polymer material, such as injected plastic material, and must have an appropriate thickness t1 to provide enough strength for bearing the external force.

For both two kinds of key caps mentioned above, however, the required strength for bearing external force limits the possible reduction of the thickness t1. If a total height of the key is fixed, the thickness t1 usually reduces the stroke distance of the spring device or the scissors-like device. The thickness t1 also reduces space under the cap and therefore makes arrangement of other elements difficult.

### SUMMARY OF THE INVENTION

It is an aspect of the present invention to provide a key cap with a multiple-layer structure. The key cap is provided for use with a mechanical key switch. The key cap may provide both desired mechanical strength for operating and enough space for arranging key elements, such as plunger device.

Another aspect of the present invention is providing a key cap with a metal outer layer for use with a key of a personal computer or a portable computer. The thickness of the metal layer is smaller than that of a traditional key cap. Thus a stroke distance of the key may be extended.

Another aspect of the present invention is providing a key cap with a polymer inner layer and a metal outer layer. The metal outer layer increases strength of the key cap. The polymer inner layer connects elements of the key.

Accordingly, the present invention provides a key cap for use with a push button switch having a plunger device. The key cap includes a first portion and a second portion. The first portion, which is considered as an inner layer, is formed by a first material. The first portion includes a bearing portion for joining the plunger device. The second portion is formed by a second material, which has higher strength than the first material. The second portion, which is considered as an outer layer, covers the first portion and includes a contact surface for bearing an external force.

This and other aspects of the present invention will become clear to those of ordinary skills in the art after having read the following detailed description of the preferred embodiments illustrated in the various figures and drawings.

### BRIEF DESCRIPTION OF THE DRAWINGS

FIG. 1 shows a traditional push button switch with a spring structure;

FIG. 2 shows a traditional push button switch with a scissors-type structure;

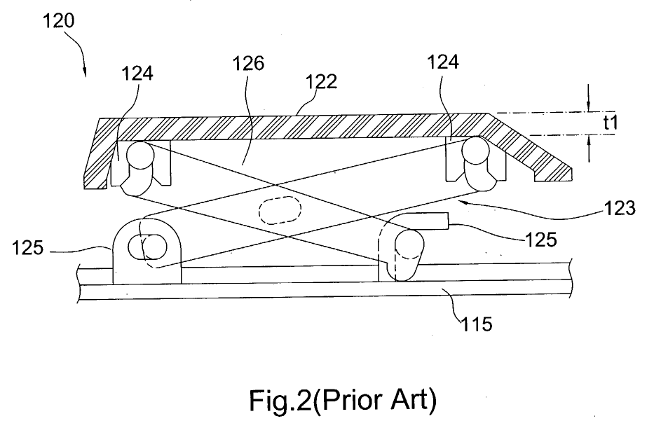

FIG. 3 shows a profile depicting a cap of a spring-type push button switch according to the present invention;

FIG. 4 shows a profile depicting a cap of a scissors-type push button switch according to the present invention;

FIG. 5a shows a bottom view of the embodiment shown in FIG. 3;

FIG. 5b shows a bottom view of the embodiment shown in FIG. 4.

### DETAILED DESCRIPTION

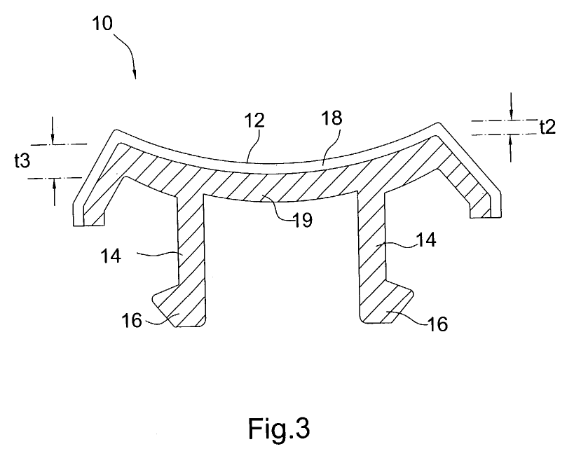

FIG. 3 shows an embodiment of a multiple-layer cap used in a spring-type push button switch according to the present invention. As FIG. 3 shows, a first portion 19 and a second portion 18 covering the first portion 19 together form the cap 10. In other words, the first portion 19 may be considered as an inner layer of the cap 10. In this embodiment, parts of the first portion 19, such as plunger 14 and hook 16, are used to connect the cap 10 with and position a plunger device. It should be noted that, besides the plunger 14 and hook 16, the first portion 19 may include structures such as a flange structure, guide rods, and a coupling frame. Moreover, the first portion 19 may be formed by various kinds of polymer materials, such as injected plastic material. The functions and shapes of the plunger 14 and hook 16 are not limited by the embodiment mentioned above. All kinds of similar structures with different shapes are included within the scope of the present invention.

In this embodiment, the second portion 18 may be considered as an outer layer of the cap 10. The shape of the second portion 18 is similar to a common key cap. One side of the second portion 18 is connected to the first portion 19. The other side includes a contact surface 12 for bearing an external force exerted on the contact surface 12. In different embodiments, the contact surface 12 may include an arc surface or a flat surface.

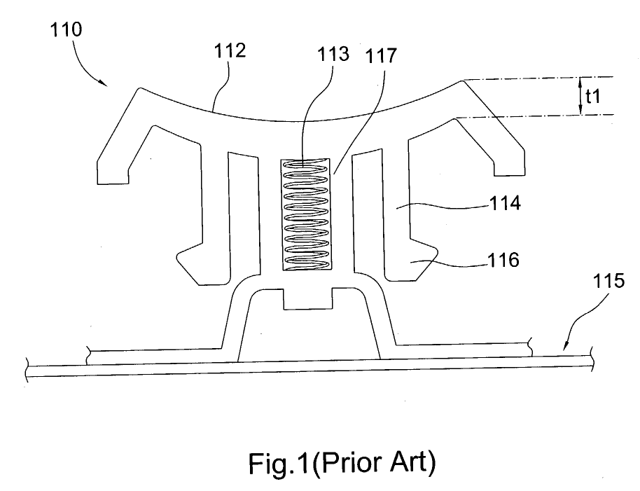

Because the contact surface 12 has to provide enough strength for bearing the external force, the second portion 18 according to the present invention may be formed of high-strength materials, such as metal. Thus, to provide the same strength, the second portion 18 may have smaller thickness than traditional polymer materials. As FIG. 3 shows, t2 is the thickness of the second portion 18, and t3 is the thickness of the first portion 19. Thus the total thickness of cap 10 is (t2+t3) and is smaller than the thickness t1 of the cap shown in FIG. 1, which is entirely formed of polymer material. Yet the strength of the cap 10 may be equal to, and even more than, the strength of the cap shown in FIG. 1. Due to the smaller thickness of the cap 10, the stroke distance of the plunger device disposed under the cap 10 may be extended. For example, with the same total key height, the deformation of spring-type plunger device may be increased if the cap 10 is thinner. It should be noted that the thickness t3 of the first portion 19 may be extremely reduced or even deleted with only the plunger 14 left to increase space under the cap 10. Thus the stroke distance of the plunger device may be extended and space for other elements may be increased.

The material of the second portion 18 may include not only single metal materials but also compound metal materials, such as alloys. The second portion 18 may be connected to the first portion 19 by various kinds of methods, such as using adhesive and/or thermal adhesion processes. In other embodiments, a connection part may be formed at a lower end of the second portion 18 to engage the first portion 19 by using an injection-molding process. Thus the cap 10 with multiple-layer structure according to the present invention not only provides enough strength for bearing the external force, but also extends the stroke distance of the plunger device and increases the space under the cap 10 for accommodating more elements.

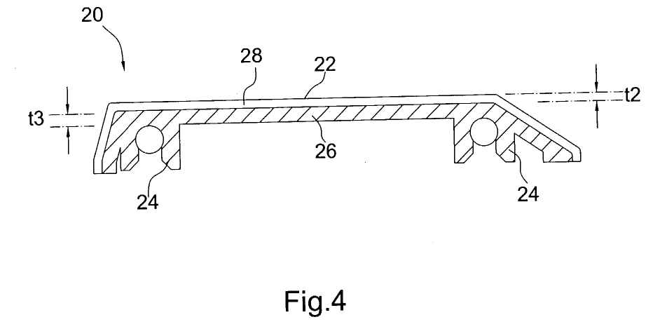

FIG. 4 shows an embodiment of a multiple-layer cap used in a scissors-type push button switch according to the present invention. As FIG. 4 shows, a first portion 26 and a second portion 28 covering the first portion 26 together form cap 20. In other words, the first portion 26 may be considered as an inner layer of the cap 20. In this embodiment, parts of the first portion 26, such as a bearing portion 24, are used to connect the cap 20 with a scissors-type structure. It should be noted that the first portion 26 may be formed by various kinds of polymer materials, such as injected plastic materials. The functions and shapes of the bearing portion 24 are not limited by the embodiment mentioned above. All kinds of similar structures with different shapes, such as a plunger and a hook, are included within the scope of the present invention.

In this embodiment, the second portion 28 may be considered as an outer layer of the cap 20. The shape of the second portion 28 is similar to a common key cap. One side of the second portion 28 is connected to the first portion 26. The other side includes a contact surface 22 for bearing an external force exerted on the contact surface 22. In different embodiments, the contact surface 22 may include an arc surface or a flat surface.

Because the contact surface 22 has to bear the external force, the second portion 28 according to the present invention may be formed by high-strength materials, such as metal material. Thus, to provide the same strength, the second portion 28 may have smaller thickness than traditional polymer materials. As FIG. 4 shows, t2 is the thickness of the second portion 28, and t3 is the thickness of the first portion. Thus the total thickness of cap 20 is (t2+t3) and is smaller than the thickness t1 of the cap shown in FIG. 1, which is entirely formed of polymer material. Yet the strength of the cap 20 may be equal to, and even more than, the strength of the cap shown in FIG. 1. Due to the higher strength and smaller thickness of the cap 20, the stroke distance of the plunger device disposed under the cap 20 may be extended. For example, with the same total key height, the stroke distance of scissors-type plunger device may be increased if the cap 20 is thinner.

The material of the second portion 28 may include not only single metal material but also compound metal material, such as alloys. The second portion 28 may be connected to the first portion 26 by various kinds of methods, such as using adhesive and/or thermal adhesion processes. In other embodiments, a connection part may be formed at a lower end of the second portion 28 to engage the first portion 26 by using an injection-molding process. Thus the cap 20 with multiple-layer structure according to the present invention not only provides enough strength for bearing the external force, but also extends the stroke distance of the plunger device and increases the space under the cap 10 for accommodating more elements.

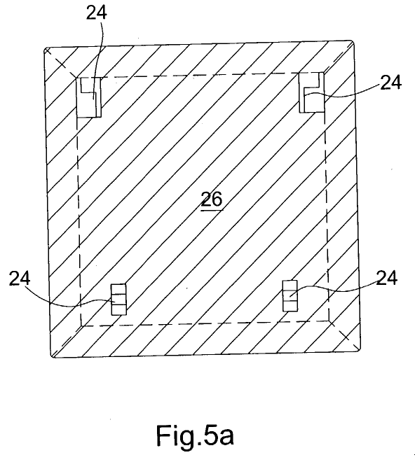

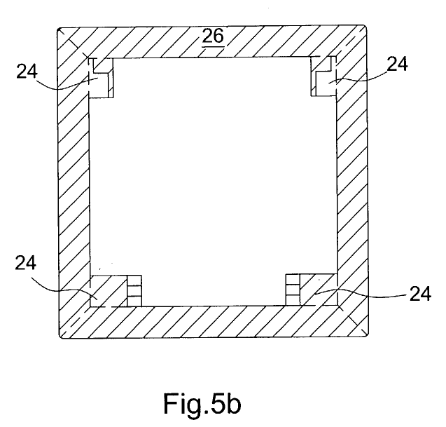

FIG. 5a and FIG. 5b respectively show bottom views of the embodiments shown in FIG. 3 and FIG. 4. As FIG. 5a shows, a part of the first portion 26 under the contact surface 12 still has a certain thickness. However, in another embodiment shown in FIG. 5b, the thickness t3 of the first portion 26 may be extremely reduced. The thickness t3 may even be deleted, leaving only an upper end of the plunger device 24 and a frame portion around the periphery of the cap 20, to increase space under the cap 20.

Those skilled in the art will readily observe that numerous modifications and alterations of the device may be made within the teaching of the invention. Accordingly, the above disclosure should be construed as limited only by the metes and bounds of the appended claims.

I claim:

1. A key cap for use with a push button switch, said push button switch having a plunger device, said key cap comprising:
a first portion formed of a first material, said first portion including at least one bearing portion connecting said plunger device; and
a second portion formed of a second material, said second portion covering said first portion, said second portion including a contact surface for bearing an external force exerted on the contact surface.

2. The key cap of claim 1, wherein a strength of said first material is lower than a strength of said second material.

3. The key cap of claim 1, wherein said second material includes a metal material.

4. The key cap of claim 3, wherein said first material includes a polymer material, a strength of said polymer material is lower than a strength of said metal material.

5. The key cap of claim 1, wherein said first portion is thicker than said second portion.

6. The key cap of claim 1, wherein said bearing portion is disposed on a first surface of said first portion, said second portion covers a second surface of said first portion, said first surface and said second surface are located at different sides of said first portion.

7. The key cap of claim 1, wherein said second portion includes at least one hook connecting said first portion.

8. The key cap of claim 1, wherein said first portion is connected to said second portion by using a thermal adhesion process.

9. The key cap of claim 1, wherein said first portion is connected to said second portion by using an injection-molding process.

10. The key cap of claim 1, wherein said plunger device includes at least one spring-type plunger device.

11. The key cap of claim 1, wherein said plunger device includes at least one scissors-type plunger device.

12. A key cap for use with a push button switch, said push button switch having a scissors-type structure, said key cap comprising:
an inner layer formed by a first material, a first surface of said inner layer including at least one bearing portion connecting said scissors-type structure;
an outer layer formed by a second material, said outer layer covering and connecting to a second surface of said inner layer; and
wherein a strength of said first material is lower than a strength of said second material.

13. The key cap of claim 12, wherein said inner layer is thicker than said outer layer.

14. The key cap of claim 12, wherein said outer layer includes at least one hook connecting said inner layer.

15. The key cap of claim 12, wherein said inner layer is connected to said outer layer by using a thermal adhesion process.

16. The key cap of claim 12, wherein said inner layer is connected to said outer layer by using an injection-molding process.

17. The key cap of claim 12, wherein said first material includes a polymer material.

18. The key cap of claim 12, wherein said second material includes a metal material.

19. A key cap having multiple-layer structure for use with a mechanical key switch, said mechanical key switch including a plunger device, said key cap comprising:
a first portion formed by a first material, said first portion including at least one bearing portion connecting said plunger device;
a second portion formed by a second material, said second portion covering said first portion, said second portion including a contact surface for bearing an external force exerted on the contact surface; and
wherein a strength of said first material is lower than a strength of said second material.
